(19) United States
(12) Patent Application Publication
(10) Pub. No.: US 2026/0038709 A1
(43) Pub. Date: Feb. 5, 2026

(54) INSULATING GAS USED FOR ELECTRICAL INSULATION OR ARC EXTINGUISHING BY REPLACING SF6 GAS AND ELECTRICAL DEVICE USING SAME

(71) Applicants: KOREA ELECTRO TECHNOLOGY RESEARCH INSTITUTE, Changwon-si (KR); KOREA RESEARCH INSTITUTE OF CHEMICAL TECHNOLOGY, Daejeon (KR)

(72) Inventors: Ki Dong SONG, Changwon-si (KR); Yeon Ho OH, Changwon-si (KR); Hyun Jae JANG, Gimhae-si (KR); In Joon PARK, Daejeon (KR); Won Wook SO, Daejeon (KR); Shin Hong YOOK, Daejeon (KR); Sang Goo LEE, Daejeon (KR); Hong suk KANG, Daejeon (KR); Ju Hyeon KIM, Daejeon (KR); Ji Hoon BAIK, Daejeon (KR); Eun Ho SOHN, Daejeon (KR); Myoung Sook LEE, Daejeon (KR); Bong Jun CHANG, Daejeon (KR)

(73) Assignees: KOREA ELECTRO TECHNOLOGY RESEARCH INSTITUTE, Changwon-si (KR); KOREA RESEARCH INSTITUTE OF CHEMICAL TECHNOLOGY, Daejeon (KR)

(21) Appl. No.: 19/355,477

(22) Filed: Oct. 10, 2025

Related U.S. Application Data
(63) Continuation of application No. 18/250,147.

(30) Foreign Application Priority Data
Oct. 23, 2020 (KR) 10-2020-0138139

(51) Int. Cl. H01B 3/56; H01H 33/56; H02B 13/055

(52) U.S. Cl. CPC H01B 3/56; H01H 33/56; H02B 13/055; H01H 2033/566

(57) ABSTRACT

The present invention relates to an insulating gas used for electrical insulation or arc extinguishing of an electrical device, and an electrical device for insulating electricity using the same. The insulating gas of the present invention, which may replace SF₆ gas, consists of a mixed gas of trifluoromethyl trifluorovinyl ether (CF₃OCFCF₂) and a carrier gas. The insulating gas of the present invention has the characteristics of a low boiling point, high dielectric strength, low toxicity, and a low global warming potential (GWP=1 or less), and thus may replace SF₆, and the low global warming potential with no loss of high insulating capacity and arc extinguishing capability may reduce greenhouse gases.

### CROSS-REFERENCE TO RELATED APPLICATIONS

This application is a continuation of U.S. patent application Ser. No. 18/250,147, filed Oct. 20, 2023 (now pending), the entire contents of which are hereby incorporated by reference. U.S. patent application Ser. No. 18/250,147 is a national stage entry of International Application No. PCT/KR2021/015042, filed Oct. 25, 2021, which claims under 35 U.S.C. §§ 119(a) and 365(b) priority to and the benefits of Korean Patent Application No. 10-2020-0138139, filed Oct. 23, 2020, the entire contents of which are hereby incorporated by reference.

### FIELD OF THE INVENTION

The present invention disclosed herein relates to an insulating gas used for electrical insulation or arc extinguishing of an electrical device, and more particularly, to an electrical device using the same.

### BACKGROUND ART

SF₆ gas is a gas artificially synthesized by Mosissan and Lebean in the 1900s. SF₆ molecules are in the form that S atoms are located in the middle, and six F atoms form an octahedron, and are chemically stable and have 2.5 times higher dielectric strength and 100 times greater arc extinguishing performance than air. The gas is an excellent material to replace air and insulating oil which have been used in the electric power industry, and has been widely used in power devices such as circuit breakers, high voltage transformers, high voltage transmission lines, and gas insulated switchgears.

However, SF₆ gas was designated as one of the six major greenhouse gases by the Kyoto Protocol in 1997, and its use is limited worldwide by 2020 due to its global warming potential 23,500 times that of CO₂ and its lifetime in the atmosphere of 3,200 years. For the reasons described above, extensive studies are ongoing in the electric power industry to develop safe, highly insulative, and environmentally friendly gases.

An insulation medium essentially satisfies the following conditions: low boiling point (below −25° C.), high dielectric strength (80% or greater than SF₆), low toxicity (high toxic concentration (5000 ppmv or greater) and negative genetic modification), and low global warming potential (GWP of 500 or less). As a limitation, a typical insulating medium fails to satisfy the four essential conditions described above as a whole.

For example, WO 2008/073790 presents a number of different compounds having low boiling points in a range of −20° C. to −273° C. and GWPs of less than 22,200, as insulating materials. However, the range of global warming potentials of individual compounds is excessively comprehensive to make it difficult to determine the eco-friendliness of the individual compounds, and no experimental data are presented in regard to dielectric strength or toxicity. In addition, although a dielectric gas mixture in which gases selected from nitrogen, CO₂, and N₂O are mixed is presented, individual characteristics of the mixed gas are not presented at all.

EP 1933432 A suggested a gas mixture of trifluoroiodomethane (CF₃I) and carbon dioxide as an insulating material. Although the gas mixture has a high dielectric strength that is 1.2 times that of SF₆, a low boiling point of −22° C., and a low global warming potential (GWP of 5), the mixture has been found to be a genotoxic substance, and thus is regarded as a major threat to the safety of related experts who have no choice but to be exposed to the gas for long.

WO 2012/080246 suggested a gas in which fluoroketone (C₅F₁₀O) and air components were mixed as an insulating material. Fluoroketone has a global warming potential of less than 1, high dielectric strength twice that of SF₆, and low acute inhalation toxicity (LC₅₀ 4 h, about 20,000 ppmv), but due to its high boiling point of 26.5° C., the gas is not applicable to power devices in polar regions and in countries having four seasons such as Korea.

WO 2013/151741 suggested a mixture of heptafluoroisobutyronitrile ((CF₃)₂CFCN) and an insulating gas containing an inert gas as an insulating material. Heptafluoroisobutyronitrile has low acute inhalation toxicity (LC₅₀ 4 h, 10,000 to 15,000 ppmv) and high dielectric strength twice that of SF₆, but its global warming potential and boiling point are relatively high at 2,100 and −4.7° C., respectively, and the mixture recently showed positive for genotoxicity. The gas described above is mixed with CO₂ and available under the brand name of g³ from 3M.

As such, as for a material to replace the SF₆ insulating gas, a great deal of research has been carried out, but still finding alternative materials that satisfy all the essential conditions required for an insulating medium has not succeeded.

### SUMMARY OF THE INVENTION

To solve the above-mentioned limitations, the present invention provides an insulating gas that satisfies 4 essential conditions: low boiling point (below −25° C.), high dielectric strength (80% or greater than SF₆), low toxicity (high toxic concentration (5000 ppmv or greater) and negative genetic modification), and low global warming potential (GWP of 500 or less), in order to replace SF₆ gas.

The present invention also provides an electric device used for eco-friendly electrical insulation or arc extinguishing using the insulating gas described above.

In accordance with an embodiment of the present invention, provided is an insulating gas used for electrical insulation or arc extinguishing of an electric device, wherein the insulating gas is a mixed gas of trifluoromethyl trifluorovinyl ether (CF₃OCFCF₂) and a carrier gas.

In addition, the mixed gas may have:
a GWP of less than 1;
an acute inhalation toxicity (LC₅₀ 4 h) of 10,000 ppmv or greater; and
a mixing ratio (k) such that a dielectric strength synergistic effect (C) defined by Equation 1 below is −0.1 or greater, −0.08 or greater, or −0.05 or greater.

$$C = \frac{k ( Vm - Va )}{( 1 - k ) ( Vm - Vb )} \qquad [ Equation 1 ]$$

(wherein k is a mixing ratio (mol %) of the trifluoromethyl trifluorovinyl ether, Vₘ is a dielectric breakdown voltage of the mixed gas, Vₐ is a dielectric breakdown voltage of the trifluoromethyl trifluorovinyl ether, and V_{b} is a dielectric breakdown voltage of the carrier gas)

In addition, the carrier gas may be CO₂, and
the mixed gas may have CF₃OCFCF₂ in a mixing ratio of 1 to 60 mol %.

In addition, the carrier gas may be CO₂, and
the mixed gas may have CF₃OCFCF₂ in a mixing ratio of 3 to 60 mol % or 5 to 60 mol %.

In addition, the carrier gas may be CO₂ and O₂,
when the mol % of CF₃OCFCF₂ represented by x, the mol % of CO₂ represented by y, and the mol % of O₂ represented by z are expressed in a triangular diagram, (x, y, z) may be outside a region surrounded by straight line AB, straight line BC, and straight line CA,
the straight line AB may be a straight line connecting point A and point B, the straight line BC may be a straight line connecting point B and point C, the straight line CA may be a straight line connecting point C and point A, and
in the point A, (x, y, z) may be (50, 0, 50), in the point B, (x, y, z) may be (5.1, 0, 94.9), and in the point C, (x, y, z) may be (8.2, 80, 11.8).

In addition, the carrier gas may be CO₂ and O₂, and
the mixed gas may have CF₃OCFCF₂ in a mixing ratio of 1 to 60 mol %, O₂ in a mixing ratio of 1 to 30 mol %, and CO₂ as the balance.

In addition, the carrier gas may be CO₂ and O₂, and
the mixed gas may have CF₃OCFCF₂ in a mixing ratio of 3 to 20 mol %, 4 to 16 mol %, or 5 to 10 mol %, O₂ in a mixing ratio of 1 to 30 mol %, 1 to 25 mol %, 1 to 20 mol %, and CO₂ as the balance.

In addition, the carrier gas may be CO₂ and O₂, and
a molar ratio of CO₂ to O₂ may be 70:30 to 99:1, 80:20 to 95:5, or 85:15 to 90:10.

Meanwhile, in accordance with the present invention, provided is an electric device configured to insulate electricity or extinguish arc through an insulating gas, wherein any one of the insulating gases described above is used.

In addition, the electric device may include:
an insulating space filled with the insulating gas inside a housing; and
a conductive member provided inside the housing.

In addition, a temperature outside the housing may be −35 to 55° C., −30 to 50° C., or −25 to 40° C., a pressure of the insulating space may be 1.5 MPaG, 1.2 MPaG, or 0.9 MPaG or less, and a voltage supplied to the conductive member may be 1 to 1100 kV, 1 to 1000 kV, or 1 to 800 kV.

### Effects of the Invention

An insulating gas of the present invention, which is used for electrical insulation or arc extinguishing instead of SF₆ gas, consists of a mixed gas of trifluoromethyl trifluorovinyl ether (CF₃OCFCF₂) and a carrier gas so as to have the characteristics of a low boiling point, high dielectric strength, low toxicity, and a low global warming potential (GWP=1 or less), and thus may replace SF₆.

In addition, an electric device using the insulating gas of the present invention is equivalent or superior to an electric device using SF₆ in terms of electrical insulation and arc extinguishing capabilities.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 shows a molecular structure of CF₃OCFCF₂ included in an insulating gas of the present invention;

FIG. 2 is a graph showing Paschen Curves of SF₆, g³, a mixed gas of CO₂ and O₂, and CF₃OCFCF₂;

FIG. 3 is a graph showing a global warming potential of a mixed gas according to a mixing ratio of CF₃OCFCF₂;

FIG. 4 shows Paschen Curves obtained by measuring 50% discharge voltages of a mixed gas of CF₃OCFCF₂ and CO₂ at different mixing ratios and SF₆, and g³;

FIG. 5 is a graph showing a dielectric strength synergistic effect according to a mixing ratio of CF₃OCFCF₂;

FIG. 6 is a graph showing results of measuring 50% discharge voltages of a mixed gas of CF₃OCFCF₂ and CO₂ at different mixing ratios, and SF₆; and

FIG. 7 is a triangular diagram of CF₃OCFCF₂, CO₂, and O₂ as three components.

### DETAILED DESCRIPTION OF THE PREFERRED EMBODIMENTS

Hereinafter, an embodiment of the present invention will be described in detail with reference to the drawings.

In order to replace SF₆ gas, a low boiling point (below −25° C.), a high dielectric strength (80% or greater than SF₆), a low toxicity (high toxic concentration (5000 ppmv or greater) and negative genetic modification), and a low global warming potential (GWP of 500 or less) are required and also chemical stability and affordable costs need to be satisfied.

As a candidate gas that satisfies the conditions described above, trifluoromethyl trifluorovinyl ether (CF₃OCFCF₂, CAS: 1187-93-5) was selected through a number of experiments.

As used herein, C₃F₆O may refer to CF₃OCFCF₂.

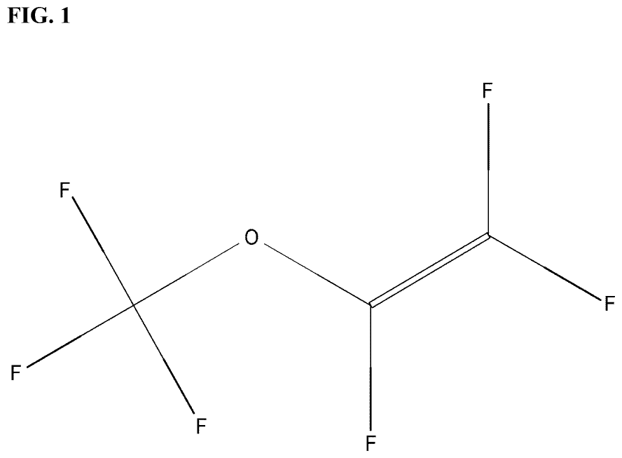

An insulating gas replacing SF₆ gas according to an embodiment of the present invention includes CF₃OCFCF₂ having a molecular structure shown in FIG. 1.

Table 1 below compares the boiling point, vapor pressure, and global warming potential of CF₃OCFCF₂ with those of SF₆ and (CF₃)₂CFCN, and shows the following results.

TABLE 1
Characteristic comparison of SF₆, (CF₃)₂CFCN, and CF₃OCFCF₂

| | Boiling point | Vapor pressure | | Acute inhalation |
|---|---|---|---|---|
| Gas | (° C.) | [psia@](20° C.) | GWP | toxicity(LC₅₀ 4 h, ppmv) |
| SF₆ | −63.7 | 334 | 23,500 | 100,000~ |
| (CF₃)₂CFCN | −4.7 | 36.7 | 2,400 | 10,000~15,000 |
| CF₃OCFCF₂ | −29 | 70.3 | 0.170 | 10,000~15,000 |

It is seen that CF₃OCFCF₂ has a very low GWP compared to (CF₃)₂CFCN, which is the main component of SF₆ and g³ gas, and has a lower boiling point than (CF₃)₂CFCN, and has an equivalent level of acute inhalation toxicity (LC₅₀ 4 h, 10,000-15,000 ppmv). In order to test the insulation performance of CF₃OCFCF₂, a 50% discharge voltage was tested with respect to a population that a lighting impulse voltage within IEC 60060-1 was applied 30 times. After each test, gas collection and electrode cleaning were performed. In this case, the 50% discharge voltage indicates a voltage at which half of standard impulse voltage waveform repeatedly applied using a sphere-plane electrode flashovers and the other half does not flashover.

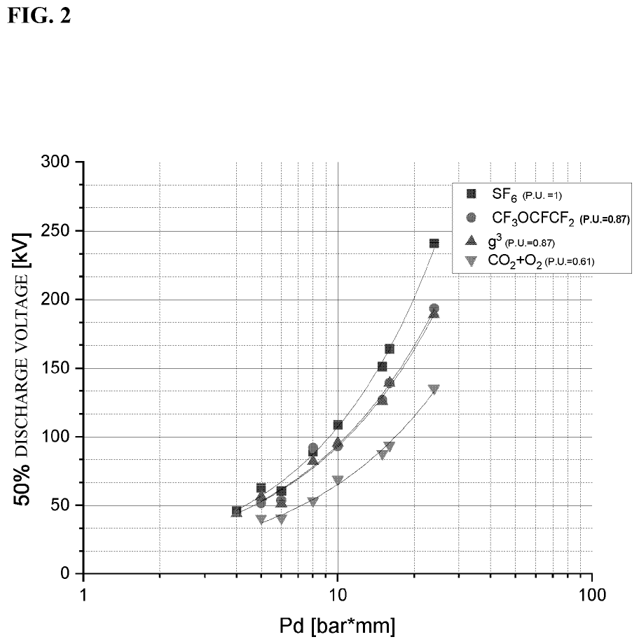

FIG. 2 shows Paschen Curves for each gas in which the 50% discharge voltage is measured for SF₆, g³((CF₃)₂CFCN), a mixed gas of CO₂ (70.5 mol %) and O₂ (29.5 mol %), and CF₃OCFCF₂. In this case, the Paschen Curve is a graph showing the 50% discharge voltage according to a pressure and distance between electrodes (sphere-plane electrode) to determine insulation performance.

The graph shows that CF₃OCFCF₂ has the same level of insulation performance as g³ gas. In addition, it is seen that CF₃OCFCF₂ is superior to the mixed gas of CO₂ (70.5 mol %) and O₂ (29.5 mol %) in the insulation performance.

Meanwhile, an insulating gas replacing SF₆ gas according to another embodiment of the present invention may be used by mixing CF₃OCFCF₂ with CO₂ and/or O2 as a carrier gas.

The mixed gas of the present invention may have a GWP of 1 or less, 0.9 or less, or 0.85 or less. In addition, the mixed gas of the present invention may have a GWP of 0.29 to 1, 0.29 to 0.9, or 0.29 to 0.85. Table 2 below shows GWP and acute inhalation toxicity (LC₅₀, ppmv) according to a mixing ratio (mol %) of CF₃OCFCF₂ and CO₂. In this case, a method for calculating GWP was based on Regulation (EU) NO 517/2014, and LC₅₀, which represents lethal concentration 50% upon inhalation for 4 hours, was based one KS B ISO 10298: 2012.

TABLE 2
GWP and acute inhalation toxicity according to
a mixing ratio (mol %) of CF₃OCFCF₂ and CO₂

| Mixture gas | GWP | LC₅₀ 4 h, ppmv |
|---|---|---|
| C₃F₆O(100%) + CO₂(0%) | 0.170 | 15,000 |
| C₃F₆O(90%) + CO₂(10%) | 0.190 | 16,529 |
| C₃F₆O(80%) + CO₂(20%) | 0.220 | 18,405 |
| C₃F₆O(70%) + CO₂(30%) | 0.250 | 20,761 |
| C₃F₆O(60%) + CO₂(40%) | 0.290 | 23,810 |
| C₃F₆O(50%) + CO₂(50%) | 0.340 | 27,907 |
| C₃F₆O(40%) + CO₂(60%) | 0.410 | 33,708 |
| C₃F₆O(30%) + CO₂(70%) | 0.490 | 42,553 |
| C₃F₆O(20%) + CO₂(80%) | 0.600 | 57,692 |
| C₃F₆O(10%) + CO₂(90%) | 0.750 | 89,552 |

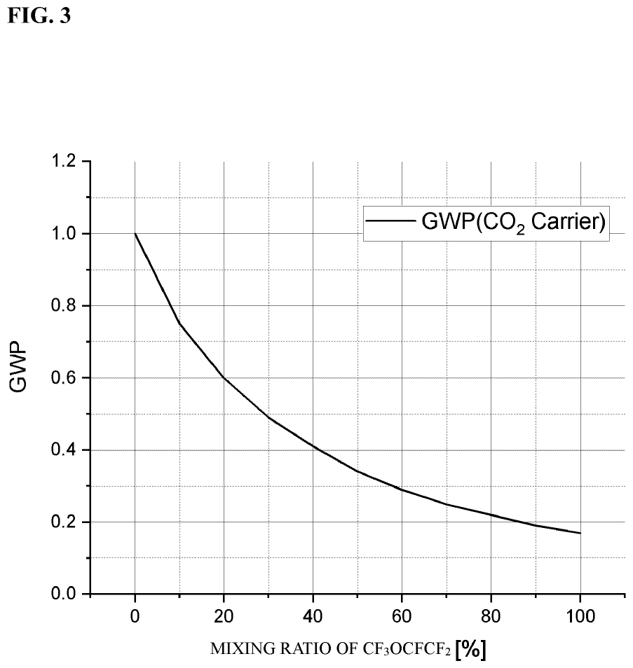

Table 2 above shows that the mixed gas of CF₃OCFCF₂ and CO₂ has a GWP of 0.190 to 0.750 when the mixing ratio of CF₃OCFCF₂ is 90 to 10 mol %, which is only about less than 0.003% compared to the GWP (23,500) of SF₆. FIG. 3 is a graph showing a global warming potential of a mixed gas according to a mixing ratio of CF₃OCFCF₂. Meanwhile, KEPCO specifies the GWP standard as 500 or less in the case of a fluorine-based mixed gas, as a general purchase standard for eco-friendly gas insulated switchgear of 72.5 kV or higher. In order to satisfy the standard, the value of GWP needs to be reduced, and it is seen that the mixed gas of CF₃OCFCF₂ and CO₂ is significantly lower than the standard described above.

In addition, the mixed gas of the present invention may have an acute inhalation toxicity ((LC₅₀ 4 h) of 10,000 ppmv or greater, 20,000 ppmv or greater, or 40,000 ppmv or greater, preferably 10,000 to 120,000 ppmv, 10,000 to 110,000 ppmv, or 10,000 to 100,000 ppmv. According to Table 2 above, the case in which the mixing ratio of CF₃OCFCF₂ is 70 mol % or less goes beyond the upper limit ((LC₅₀=20,000 ppmv) of grade 4 acute inhalation toxicity with respect to the Globally Harmonized System of Classification and Labeling of Chemicals, and thus may be classified as toxicity grade 4 or higher.

In order to measure the dielectric strength according to the mixing ratio of the mixed gas of CF₃OCFCF₂ and CO₂, the same insulation performance test method for CF₃OCFCF₂ was performed.

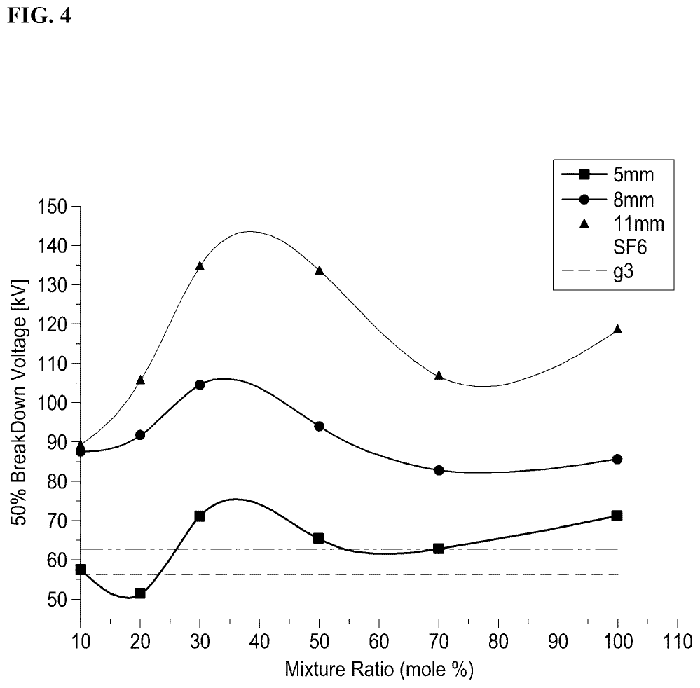

FIG. 4 shows a graph of test results obtained by measuring 50% discharge voltages of a mixed gas of CF₃OCFCF₂ and CO₂ at different mixing ratios. In this case, 5 mm, 8 mm, and 11 mm indicate 50% discharge voltages when the distance between sphere and plane electrodes is 5 mm, 8 mm, and 11 mm, respectively, for the mixed gas of CF₃OCFCF₂ and CO₂, and SF₆ and g³ indicate 50% discharge voltages when the distance between sphere and plane electrodes is 5 mm. Accordingly, it is seen that the mixed gas of CF₃OCFCF₂ and CO₂ showed a nonlinear pattern in the 50% discharge voltage according to the mixing ratio, and had 87% to 130% of dielectric strength compared to SF₆.

Specifically, the mixed gas of CF₃OCFCF₂ and CO₂ is superior to SF₆ and g³ gases in the 50% discharge voltage regardless of the mixing ratio of CF₃OCFCF₂ when the distance between electrodes is 8 mm and 11 mm. In addition, it was found that the mixed gas of CF₃OCFCF₂ and CO₂ was superior to SF₆ and g³ gases in the 50% discharge voltage, except when the distance between electrodes was relatively small (5 mm) and the mixing ratio of CF₃OCFCF₂ was low (10 to 23 mol %). In particular, it is seen that when the mixing ratio of CF₃OCFCF₂ is 30 mol %, the 50% discharge voltage is 113% better than SF₆ and 126% better than g³ gas.

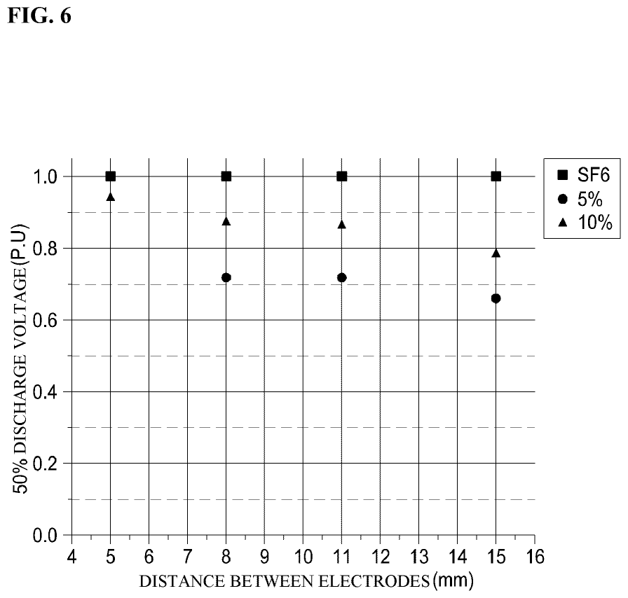

FIG. 6 shows the results of a test (IEC 60060-1 lightning impulse test) measuring 50% discharge voltage of the mixed gas of CF₃OCFCF₂ and CO₂ at different mixing ratios and SF₆. As for a test electrode, the 50% discharge voltage was measured by applying Rogowski profile (field utilization factor of 0.94 to 1) and setting a distance between plane and plane electrodes to 5 mm, 8 mm, 11 mm, and 15 mm at atmospheric pressure.

The results of the experiment show that a mixed gas of 5% CF₃OCFCF₂ and 95% CO₂ had a dielectric strength of 66% to 72% compared to SF₆, and a mixed gas of 10% CF₃OCFCF₂ and 90% CO₂ had a dielectric strength of 78% to 94% compared to SF₆, indicating that the insulating gas of the present invention may replace SF₆.

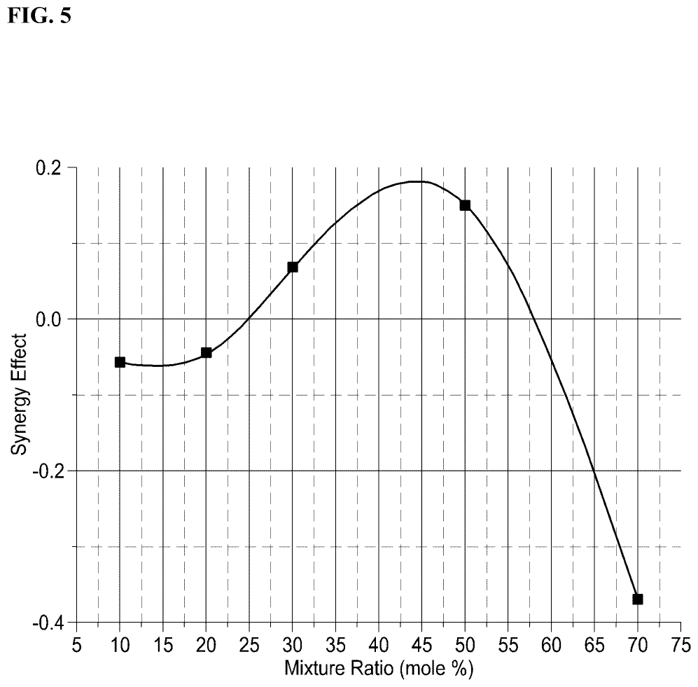

The insulating gas of the present invention may have a synergistic effect of −0.1 or greater, −0.08 or greater, or −0.05 or greater. FIG. 5 is a graph showing a dielectric strength synergistic effect according to a mixing ratio of CF₃OCFCF₂. The dielectric strength synergistic effect (C) is obtained by Equation 1 below.

$$C = \frac{k ( Vm - Va )}{( 1 - k ) ( Vm - Vb )} \qquad [ Equation 1 ]$$

(wherein k is a mixing ratio (mol %) of the trifluoromethyl trifluorovinyl ether, Vₘ is a dielectric breakdown voltage of the mixed gas, Vₐ is a dielectric breakdown voltage of the trifluoromethyl trifluorovinyl ether, and V_{b} is a dielectric breakdown voltage of the carrier gas)

Referring to FIG. 5, the dielectric strength synergistic effect shows a nonlinear pattern according to the mixing ratio of CF₃OCFCF₂ Specifically, the dielectric strength synergistic effect (C) is 0 or greater when the mixing ratio of CF₃OCFCF₂ is within the range of 25 to 58 mol %, the dielectric strength synergistic effect (C) value is −0.05 or greater when the mixing ratio of CF₃OCFCF₂ is 20 to 60 mol %, and the dielectric strength synergistic effect (C) value is −0.1 or greater when the mixing ratio of CF₃OCFCF₂ is 10 to 62 mol %. In addition, it is reasonably inferred that the dielectric strength synergistic effect value may be −0.1 or greater or −0.08 or greater for 10 mol % or less. In this case, even when the dielectric strength synergistic effect value corresponds to a (−) value, as shown in FIG. 4, it is seen that the 50% discharge voltage is higher than that of SF₆ or g³ gas, except when the distance between electrodes is very small.

Meanwhile, insulating gases used in electric devices that insulate electricity or extinguish arc are not supposed to belong to the category of combustible gases. In accordance with KS B ISO 10156: 2017, standards for combustible gases are set as shown in the following table.

TABLE 3
Standards for combustible gas

| Category | Standard |
|---|---|
| 1 | One of the following gases at 20° C. and a standard pressure of 101.3 kPa |
| | a) Ignitable when in a mixture having a volume fraction of less than 13% in air. |
| | or |
| | b) having a flammability range with air of at least 12% points regardless of |
| | lower flammability limit. |
| 2 | Gases having a flammability range when mixed with air at 20° C. and a standard |
| | pressure of 101.3 kPa, except for gases belonging to category 1. |

The calculation results of the lower flammability limit (LFL) according to the mixing ratio of the mixed gas of CF₃OCFCF₂ and CO₂ are shown in the following table. In this case, the lower flammability limit is a concentration range in which flame propagation may take place when a combustible gas is mixed with air and ignited, expressed in volume concentration (vol %), and refers to the lowest value in this volume concentration.

TABLE 4
Lower flammability limit according to the mixing ratio
of CF₃OCFCF₂ of a mixed gas of CF₃OCFCF₂ of CO₂

| | | | | | | | | |
|---|---|---|---|---|---|---|---|---|
| Mixing ratio | 100 | 90 | 80 | 70 | 60 | 50 | 40 | 30 |
| of | | | | | | | | |
| CF₃OCFCF₂ | | | | | | | | |
| Lower | 7.5 | 8.37 | 9.47 | 10.9 | 12.84 | 15.61 | 19.89 | 27.36 |
| flammability | | | | | | | | |
| limit | | | | | | | | |
| (LFL) | | | | | | | | |

According to the experiment described above, it is seen that the case in which the mixing ratio of CF₃OCFCF₂ is 60% or less is out of the category of combustible gas category 1.

Meanwhile, preferably, the insulating gas does not react with electrodes or housings used in electrical devices for electrical insulation or arc extinguishing.

It was found that when CF₃OCFCF₂ was used alone as an insulating gas, CF₃OCFCF₂ reacted with electrodes at atmospheric pressure to form a carbon film, but when the mixing ratio of CF₃OCFCF₂ in the mixed gas of CF₃OCFCF₂ and CO₂ was less than 70%, CF₃OCFCF₂ did not react with electrodes.

In this case, the reactivity test was to determine a reaction with electrodes upon testing dielectric strength for each mixing ratio of the insulating gases in an enclosed space where no external gas was not allowed to enter (insulation test chamber), at R.T. (room temperature), and at a standard atmospheric pressure of 1 atm. In this case, materials of a sphere electrode are CuCr and Wcu, and materials of a plane electrode are CuCr and SUS.

Accordingly, as for the mixed gas of CF₃OCFCF₂ and CO₂, the mixing ratio of CF₃OCFCF₂ may be 1 to 60 mol %, 3 to 60 mol %, or 5 to 60 mol %, more preferably 1 to 20 mol %, 3 to 15 mol %, or 5 to 10 mol %, and the balance may be CO₂. In the above range, the mixed gas had excellent global warming potential (GWP) and dielectric strength, had a low chance of flame propagation, and did not react to electrodes and SUS used in electric devices for electrical insulation or arc extinguishing, and thus it was found that the mixed gas was suitable as an alternative gas for SF₆.

According to the present invention, the replacement of SF₆ gas designated as a greenhouse gas with the mixed gas of CF₃OCFCF₂ and CO₂ prevents loss of insulation performance compared to using SF₆ gas, and allows a low global warming potential, thereby reducing harmful effects on the environment.

Meanwhile, it was found from the results of analyzing the components generated after arc extinguishing of CF₃OCFCF₂ that trifluoromethane (CHF₃), hexafluoroethane (C₂F₆), tetrafluoroethane (C₂F₄), octafluoropropane (C₃F₈), hexafluoro ropropen (C₃F₆), and decafluorobutane (C₄F₁₀) were generated, and carbon compounds were generated from the substances.

Toxic by-products of the carbon compounds generated after arc extinguishing may be effectively reduced or avoided by using O₂.

In this aspect, the carrier gas of the present invention may be CO₂ and O₂.

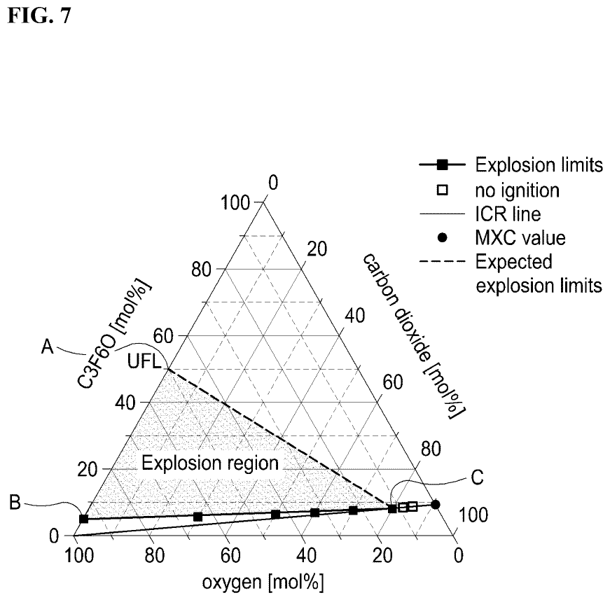

When the carrier gas of the insulating gas according to the present invention is CO₂ and O₂, when the mol % of CF₃OCFCF₂ represented by x, the mol % of CO₂ represented by y, and the mol % of O₂ represented by z are expressed in a triangular diagram with respect to a total amount of CF₃OCFCF₂, CO₂, and O₂, as shown in FIG. 7, (x, y, z) may be outside a region surrounded by straight line AB, straight line BC, and straight line CA. As shown in FIG. 7, this means that (x, y, z) is outside the Explosion region indicated by triangle ABC.

In this case, the straight line AB may be a straight line connecting point A and point B, the straight line BC may be a straight line connecting point B and point C, the straight line CA may be a straight line connecting point C and point A, and in the point A, (x, y, z) may be (50, 0, 50), in the point B, (x, y, z) may be (5.1, 0, 94.9), and in the point C, (x, y, z) may be (8.2, 80, 11.8). Unlike the case above, when (x, y, z) is present in the triangle ABC (explosion triangle) composed of the points A, B, and C, there may be an explosion hazard due to flammability.

In FIG. 7, the explosion limits indicate the explosion limit line, and is a line connecting the explosion limit points (filled square points). On the other hand, no ignition (hollow rectangle points) indicates a non-ignition point. Coordinates of the explosion limit points and non-ignition points are shown in Table 5 below.

TABLE 5
Gas composition in mol %

| C3F6O | CO2 | O2 | Remarks |
|---|---|---|---|
| 5.1 | 0.0 | 94.9 | LEL |
| 5.7 | 30.0 | 64.3 | |
| 6.6 | 50.0 | 43.4 | |
| 7.0 | 60.0 | 33.0 | |
| 7.6 | 70.0 | 22.4 | |
| 8.2 | 80.0 | 11.8 | Point of tangency of ICR line |
| 8.6 | 82.5 | 8.9 | No ignition confirmed at 8.6% C3F6O |
| 8.8 | 85.0 | 6.2 | No ignition confirmed at 8.8% C3F6O |

In addition, point A in the triangular diagram of FIG. 7 represents upper flammability limit (UFL), and when point A is connected to point C, which is an end point on the explosion limit line, a straight line AC, which is an expected explosion limit (expected line), is formed. Accordingly, it was found that the explosion triangle ABC would be formed by connecting the end points B and C, which are the end points on the explosion limit line, and the point A, and that non-flammability would be achieved when the composition of the insulating gas is present outside the explosion triangle. Meanwhile, the ICR line on the triangle diagram is tangent to the explosion triangle passing through 100% of O₂, and the MXC value is 9.3% (C₃F₆O in CO₂).

More specifically, the carrier gas is CO₂ and O₂, the mixed gas has CF₃OCFCF₂ in a mixing ratio of 1 to 60 mol % and 02 in a mixing ratio of 1 to 30 mol %, and the balance may be composed of CO₂. More preferably in terms of insulation and stability, the mixed gas may have CF₃OCFCF₂ in a mixing ratio of 3 to 20 mol %, 4 to 16 mol %, or 5 to 10 mol %, O₂ in a mixing ratio of 1 to 30 mol %, 1 to 25 mol %, 1 to 20 mol %, and CO₂ as the balance.

When the mixing molar ratio of CF₃OCFCF₂ is greater than the above range, a synergistic effect or stability may be reduced, whereas when the mixing molar ratio of CF₃OCFCF₂ is less than the above range, insulation performance may be hardly effective. In addition, when the mixing molar ratio of O₂ is greater than the above range, flammability may increase, whereas when the mixing molar ratio of O₂ is less than the above range, the effect of reducing toxic by-products of the carbon compound may decrease.

In addition, when the carrier gas is CO₂ and O₂, the molar ratio of CO₂ and O₂ may be 70:30 to 99:1, 80:20 to 95:5, or 85:15 to 90:10. When the mixing molar ratio of O₂ to CO₂ is greater than the above range, flammability may increase, whereas when the mixing molar ratio of O2 is less than the above range, the effect of reducing toxic by-products of the carbon compound may decrease.

In addition, according to a preferred embodiment of the present invention, pure O₂ and also a gas mixture containing O₂, particularly air containing O₂ may be used for the mixed gas of CF₃OCFCF₂ and CO₂.

Meanwhile, an electric device corresponding to another aspect of the present invention is an electric device that insulates electricity or extinguishes arc through an insulating gas, and may insulate electricity or extinguish arc, using the insulating gas of the embodiment described above.

These electrical devices include gas transmission lines, gas insulated switchgear, Ring Main Unit (RMU), DC protection devices, and power distribution systems, and may be applicable to renewable energy such as solar and wind power, long-distance power transmission, and emergency power devices.

High voltage circuit breakers and gas insulated switchgears using the insulating gas of the present invention may be applicable to both a high voltage of 72.5 to 800 kV and a medium voltage of 1 to 72.5 kV, and are particularly suitable for high voltage areas.

The electric device (e.g., a high voltage circuit breaker or a gas insulated switchgear) of the present invention includes an insulating space filled with the insulating gas of the present invention inside a housing, and a conductive member provided inside the housing.

In this case, a temperature outside the housing may be −35 to 55° C., −30 to 50° C., or −25 to 40° C., and an average temperature for 24 hours may be about 35° C. In addition, a pressure in the insulating space may be 1.5 MPaG 1.2 MPaG; or 0.9 MPaG or less, and a voltage supplied to the conductive member may be 1 to 1100 kV, 1 to 1000 kV, or 1 to 800 kV.

Although the specific embodiments of the present invention are described with reference to the accompanying drawings, it should be apparent that the scopes of the present invention affect equivalents and modifications within the technical spirit as set forth in the claims.

What is claimed is:

1. An insulating gas used for electrical insulation or arc extinguishing of an electrical device, wherein the insulating gas is a mixed gas of trifluoromethyl trifluorovinyl ether (CF₃OCFCF₂) and a carrier gas; and
wherein, when a 50% discharge voltage is measured for the mixed gas and SF6 with the distance between sphere and plane electrodes being 5 mm, respectively, and the mixed gas is measured while varying a mixing ratio, a mixing ratio region exists in which the discharge voltage of the mixed gas is higher than that of the SF6.

2. An insulating gas used for electrical insulation or arc extinguishing of an electrical device, wherein the insulating gas is a mixed gas of trifluoromethyl trifluorovinyl ether (CF₃OCFCF₂) and a carrier gas; and
wherein, when a 50% discharge voltage is measured for the mixed gas and SF6 with the distance between sphere and plane electrodes being 8 mm, respectively, and the mixed gas is measured while varying a mixing ratio, a peak value of the discharge voltage exists in a region where the mixing ratio of the trifluoromethyl trifluorovinyl ether is 70% or less.

3. The insulating gas of claim 1, wherein the mixed gas shows a nonlinear pattern in the 50% discharge voltage according to the mixing ratio.

4. The insulating gas of claim 2, wherein the mixed gas shows a nonlinear pattern in the 50% discharge voltage according to the mixing ratio.

5. The insulating gas of claim 1, wherein the mixed gas has:
a mixing ratio (k) such that a dielectric strength synergistic effect (C) defined by Equation 1 below is −0.1 or greater,
$$C = \frac{k ( Vm - Va )}{( 1 - k ) ( Vm - Vb )} \qquad [ Equation 1 ]$$
(wherein k is a mixing ratio (mol %) of the trifluoromethyl trifluorovinyl ether, Vₘ is a dielectric breakdown voltage of the mixed gas, Vₐ is a dielectric breakdown voltage of the trifluoromethyl trifluorovinyl ether, and V_{b} is a dielectric breakdown voltage of the carrier gas).

6. The insulating gas of claim 2, wherein the mixed gas has:
a mixing ratio (k) such that a dielectric strength synergistic effect (C) defined by Equation 1 below is −0.1 or greater,
$$C = \frac{k ( Vm - Va )}{( 1 - k ) ( Vm - Vb )} \qquad [ Equation 1 ]$$
(wherein k is a mixing ratio (mol %) of the trifluoromethyl trifluorovinyl ether, Vₘ is a dielectric breakdown voltage of the mixed gas, Vₐ is a dielectric breakdown voltage of the trifluoromethyl trifluorovinyl ether, and V_{b} is a dielectric breakdown voltage of the carrier gas).

7. The insulating gas of claim 5, wherein the carrier gas is CO₂, and
the mixed gas has CF₃OCFCF₂ in a mixing ratio of 1 to 60 mol %.

8. The insulating gas of claim 6, wherein the carrier gas is CO₂, and
the mixed gas has CF₃OCFCF₂ in a mixing ratio of 1 to 60 mol %.

9. The insulating gas of claim 5, wherein the carrier gas is CO₂ and O₂,
when the mol % of CF₃OCFCF₂ represented by x, the mol % of CO₂ represented by y, and the mol % of O₂ represented by z are expressed in a triangular diagram, (x, y, z) is outside a region surrounded by straight line AB, straight line BC, and straight line CA, and
the straight line AB is a straight line connecting point A and point B, the straight line BC is a straight line connecting point B and point C, the straight line CA is a straight line connecting point C and point A, and in the point A, (x, y, z) is (50, 0, 50), in the point B, (x, y, z) is (5.1, 0, 94.9), and in the point C, (x, y, z) is (8.2, 80, 11.8).

10. The insulating gas of claim 6, wherein the carrier gas is CO₂ and O₂,
when the mol % of CF₃OCFCF₂ represented by x, the mol % of CO₂ represented by y, and the mol % of O₂ represented by z are expressed in a triangular diagram, (x, y, z) is outside a region surrounded by straight line AB, straight line BC, and straight line CA, and
the straight line AB is a straight line connecting point A and point B, the straight line BC is a straight line connecting point B and point C, the straight line CA is a straight line connecting point C and point A, and in the point A, (x, y, z) is (50, 0, 50), in the point B, (x, y, z) is (5.1, 0, 94.9), and in the point C, (x, y, z) is (8.2, 80, 11.8).

11. The insulating gas of claim 5, wherein the carrier gas is CO₂ and O₂, and
the mixed gas has CF₃OCFCF₂ in a mixing ratio of 1 to 60 mol %, O₂ in a mixing ratio of 1 to 30 mol %, and CO₂ as the balance.

12. The insulating gas of claim 6, wherein the carrier gas is CO₂ and O₂, and
the mixed gas has CF₃OCFCF₂ in a mixing ratio of 1 to 60 mol %, O₂ in a mixing ratio of 1 to 30 mol %, and CO₂ as the balance.

13. The insulating gas of claim 5, wherein the discharge voltage is measured at atmospheric pressure.

14. The insulating gas of claim 6, wherein the discharge voltage is measured at atmospheric pressure.

15. An electric device configured to insulate electricity or extinguish arc through an insulating gas, wherein the insulating gas of claim 1 is used.

16. An electric device configured to insulate electricity or extinguish arc through an insulating gas, wherein the insulating gas of claim 2 is used.

17. The electric device of claim 15, comprising an insulating space filled with the insulating gas inside a housing, and a conductive member provided inside the housing.

18. The electric device of claim 16, comprising an insulating space filled with the insulating gas inside a housing, and a conductive member provided inside the housing.
